(19) United States
(12) Patent Application Publication
(10) Pub. No.: US 2009/0044906 A1
(43) Pub. Date: Feb. 19, 2009

(54) METHOD FOR DECORATING SURFACES

(75) Inventors: Rainer Goring, Borken (DE); Martin Wielputz, Senden (DE); Franz-Erich Baumann, Dulmen (DE); Karl Kuhmann, Dulmen (DE); Sylvia Monsheimer, Haltern am See (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 12/192,208

(22) Filed: Aug. 15, 2008

(30) Foreign Application Priority Data
Aug. 16, 2007 (DE) 102007038578.3

(51) Int. Cl. B32B 37/06

(52) U.S. Cl. 156/272.8

(57) ABSTRACT

The surface of a shaped article produced in a first step, for example by means of rapid prototyping, is subsequently decorated by a method for the production of a surface-decorated shaped article in which
a) a shaped article is provided, and
b) at least a portion of the surface of the shaped article is welded to a decorating film with incidence of electromagnetic radiation.

### BACKGROUND OF THE INVENTION

1. Field of the Invention

The invention relates to a method for decorating surfaces, in which a one-layer or multilayer film is applied with the aid of electromagnetic radiation.

2. Discussion of the Background

Shaped plastics articles can be joined to one another by a very wide range of plastics welding methods, for example high-frequency welding, thermal impulse welding, thermal contact welding, or heated wedge welding or with the aid of electromagnetic radiation, such as laser light, IR or microwave radiation. In laser transmission welding, a laser-transparent part to be joined and a laser absorbing joining partner are usually used. The laser radiation passes through the transmitting body and strikes the adjacent absorbing moulding which melts as a result of the local heating. However, the laser beam which passes through the transmitting part to be joined should not penetrate too deeply into the absorbing joining partner during joining but should lead to melting of the absorbing shaped article in the surface regions themselves. This results in advantageous, local conversion of the laser beam into heat within the joining zone. The expanding melt touches the transmitting joining partner and also melts it locally. Contact pressure supports the formation of the joint. The heat is introduced in a targeted manner and cannot escape prematurely to the outside. Thermoplastics in the unfilled state are very substantially transparent to laser light at wavelengths which are usually used for laser transmission welding. An advantage over the other welding methods is a very good optical appearance of the joint and the locally limited heating of the joining zone. The same applies to welding by means of IR radiation or other electromagnetic radiation.

It is already known that shaped articles and films can be welded to one another by means of electromagnetic radiation, for example laser radiation (DE 195 42 328 A1; DE 199 16 786 A1; WO 02/055287). Construction joints are obtained thereby. Methods for decorating a surface in this manner are unknown to date.

The decoration of a surface may serve various purposes:

a) The surface of a shaped article which was produced by rapid prototyping or rapid manufacturing is often rough and aesthetically not very appealing.

b) The same applies to a shaped article which was produced from a moulding material reinforced with fibers or fillers.

c) Frequently, there is a need to apply emblems, colored decorative elements, labels or identifications to shaped articles.

d) In addition, it is very desirable to protect a surface which is not sufficiently scratch-resistant, resistant to weathering, resistant to chemicals or resistant to stress cracking under conditions of use so that it shows no traces of use and, for example, retains its gloss.

EP 0 568 988 A1 discloses that surface-resistant components can be produced by in-mould injection moulding of a film which is a protective layer with a thermoplastic melt. Here, the film is already joined to the shaped article during the production of the latter. This method is not suitable for shaped articles which are produced by rapid prototyping or rapid manufacturing.

### SUMMARY OF THE INVENTION

It was therefore the object to develop a process for subsequently decorating the surface in the case of a shaped article produced in a first step, in order, for example, to be able to decorate shaped articles which cannot be produced by means of injection moulding, or in order to be able to apply changing decorative elements or to produce small series.

This and other objects have been achieved by the present invention the first embodiment of which includes a method for the production of a surface-decorated shaped article, comprising:

a) providing a shaped article; and

b) welding at least a portion of the surface of the shaped article to a decorating film with incidence of electromagnetic radiation.

### DETAILED DESCRIPTION OF THE INVENTION

The present invention provides a method for the production of a surface-decorated shaped article, in which

a) a shaped article is provided, and

b) at least a portion of the surface of the shaped article is welded to a decorating film with incidence of electromagnetic radiation.

In one embodiment, the shaped article is produced by rapid prototyping or rapid manufacturing. Here, a film is welded on in order to provide the part with a smooth surface. In addition, the film may perform further decorative functions. The terms “rapid prototyping” and “rapid manufacturing” mean moldless methods operating layer by layer (i.e. methods without a prefabricated mould), in which regions of the respective pulverulent layer are selectively melted and, after cooling, are solidified. Examples of this are selective laser sintering (U.S. Pat. No. 6,136,948; WO 96/06881), the SIV method as described in WO 01/38061, or a method as is evident from EP-A-1 015 214. The last two methods operate with infrared panel heating for melting the powder. The selectivity of the melting is achieved in the first method by application of an inhibitor and in the second method by means of a mask. A further method is described in DE-A-103 11 438; here, the energy required for melting is introduced by a microwave generator and the selectivity is achieved by application of a susceptor. Further suitable methods are those which operate with an absorber which is either present in the powder or which is applied by inkjet methods, as described in the German patent applications DE 10 2004 012 682.8, DE 10 2004 012 683.6 and DE 10 2004 020 452.7. A large laser bandwidth can be used for the action of the electromagnetic energy, but the action of the electromagnetic energy over an area is also suitable.

The powder used for these methods can be prepared by milling the moulding material, preferably at low temperatures. The milled material can then be fractionated in order to remove coarse particles or very fine particles. Mechanical after-treatment, for example in a high-speed mixer for rounding the particles, can also be subsequently effected. It is advisable to treat the powder thus obtained, according to the background art, with a flow improver, for example with pyrogenic silica, which is mixed in by dry blending. Preferably, the powder thus obtained has a number average particle diameter of from 40 to 120 μm and a BET surface area of less than 10 m²/g.

In a further embodiment, the shaped article comprises a moulding material reinforced with fibers and/or fillers. Suitable fibers and fillers and suitable compositions are stated further below. Particularly in the case of relatively high degrees of filling, the fillers and reinforcing materials are forced to the outside at the surface, which results in a rough surface. Apart from this, such a surface may undergo weathering or chalking, particularly with non-optimal binding of the fillers and reinforcing materials. This is prevented by the method according to the invention.

In yet a further embodiment, a film which contains emblems, colored decorative elements or identifications or represents a label is applied to a shaped article of any kind. The shaped article may have been produced by extrusion, injection moulding or any other shaping method.

Finally, in another embodiment, a film is applied to a surface which would develop traces of use under conditions of use since, for example, it is not sufficiently scratch-resistant, resistant to weathering, resistant to chemicals or resistant to stress cracking. Suitable film materials are known; examples are stated further below.

The shaped articles used according to the invention usually contain thermoplastic polymers but may also be formed from ceramic, natural substances, such as wood or leather, thermosetting plastics or metal. They may also have a multi-component, e.g. multilayer, composition.

Suitable thermoplastic polymers are all thermoplastics known to the person skilled in the art. Suitable thermoplastic polymers are described, for example, in Kunststoff-Taschenbuch, published by Saechtling, 25th edition, Hanser-Verlag, Munich, 1992, in particular chapter 4 and the references cited therein, and in Kunststoff-Handbuch, Editors G. Becker and D. Braun, volumes 1 to 11, Hanser-Verlag, Munich, 1966 to 1996.

The following may be mentioned by way of example as suitable thermoplastics: polyoxyalkylenes, polycarbonates (PC), polyesters, such as polybutylene terephthalate (PBT) or polyethylene terephthalate (PET), polyolefins, such as polyethylene or polypropylene, poly(meth)acrylates, polyamides, vinylaromatic (co)polymers, such as polystyrene, high-impact polystyrene, such as HIPS, or ASA, ABS or AES polymers, polyarylene ethers, such as polyphenylene ether (PPE), polysulfones, polyurethanes, polylactides, halogen-containing polymers, polymers containing imido groups, cellulose esters, silicone polymers and thermoplastic elastomers. It is also possible to use blends of different thermoplastics as materials for the shaped plastics articles. These blends may be one phase or multiphase polymer blends.

Polyoxyalkylenehomo or copolymers, in particular (co)polyoxymethylenes (POM), and processes for the preparation thereof are known per se to the person skilled in the art and are described in the literature. Suitable materials are commercially available, for example under the brand name Ultraform® (BASF AG). Very generally, these polymers have at least 50 mol % of repeating units —CH₂O— in the polymer main chain. The homopolymers are generally prepared by polymerization of formaldehyde or trioxane, preferably in the presence of suitable catalysts. Polyoxymethylene copolymers and polyoxymethylene terpolymers are preferred. The preferred polyoxymethylene(co)polymers have melting points of at least 150° C. and molecular weights (weight average) M_{w} in the range from 5000 to 200 000, preferably from 7000 to 150 000 g/mol. Terminal group-stabilized polyoxymethylene polymers which have C—C bonds at the chain ends are particularly preferred.

Suitable polycarbonates are known per se and are obtainable, for example according to DE-B-13 00 266, by interfacial polycondensation or, according to DE-A 14 95 730, by reaction of biphenyl carbonate with bisphenols. A preferred bisphenol is 2,2 di(4-hydroxyphenyl)propane, generally referred to as bisphenol A. Suitable polycarbonates are commercially available, for example under the brand name Lexan® (GE Plastics B. V., The Netherlands).

Suitable polyesters are likewise known per se and are described in the literature. They contain an aromatic ring in the main chain, which ring originates from an aromatic dicarboxylic acid. The aromatic ring may also be substituted, for example by halogen, such as chlorine or bromine, or by C₁-C₄ alkyl groups, such as methyl, ethyl, isopropyl or n propyl or n butyl, isobutyl or tert-butyl groups. The polyesters can be prepared by reaction of aromatic dicarboxylic acids, esters thereof or other ester-forming derivatives thereof with aliphatic dihydroxy compounds in a manner known per se. Naphthalene dicarboxylic acid, terephthalic acid and isophthalic acid or mixtures thereof may be mentioned as preferred dicarboxylic acids. Up to 30 mol % of the aromatic dicarboxylic acids may be replaced by aliphatic or cycloaliphatic dicarboxylic acids, such as adipic acid, azelaic acid, sebacic acid, dodecanedioic acid or cyclohexane dicarboxylic acid. Among the aliphatic dihydroxy compounds, diols having 2 to 6 carbon atoms, in particular 1,2-ethanediol, 1,4-butanediol, 1,6-hexanediol, 1,4-hexanediol, 1,4-cyclohexanedimethanol and neopentylglycol or mixtures thereof are preferred. Polyalkylene terephthalates which are derived from alkane diols having 2 to 6 C atoms may be mentioned as particularly preferred polyesters. Among these, polyethylene terephthalate (PET), polyethylene naphthalate, polybutylene naphthalate and polybutylene terephthalate (PBT) are particularly preferred.

Suitable polyolefins are primarily polyethylene and polypropylene and copolymers based on ethylene or propylene, if desired also with higher a olefins. Polyolefins are also to be understood as meaning ethylene-propylene elastomers and ethylene-propylene terpolymers.

In particular, polymethyl methacrylate (PMMA) and copolymers based on methyl methacrylate with up to 40% by weight of further copolymerizable monomers, such as n butyl acrylate, tert-butyl acrylate or 2-ethylhexyl acrylate, as are available, for example, under the names Lucryl® (BASF AG) or Plexiglas® (Röhm GmbH), may be mentioned among the poly(meth)acrylates. In the context of the invention, these are also to be understood as meaning impact-modified poly(meth)acrylates and mixtures of poly(meth)acrylates and SAN polymers which have been impact-modified with polyacrylate rubbers (e.g. the commercial product Terlux® from BASF AG).

In the context of the present invention, all known polyamides, including polyetheramides and polyether block amides and blends thereof are to be understood among polyamides. Examples of these are polyamides which are derived from lactams having 7 to 13 ring members, such as polycaprolactam, polycapryllactam and polylaurolactam, and polyamides which are obtained by reaction of dicarboxylic acids with diamines. The polyamides may also be completely aromatic or partly aromatic; the latter are usually referred to as PPA.

Alkane dicarboxylic acids having 6 to 22, in particular 6 to 12, carbon atoms and aromatic dicarboxylic acids may be used as dicarboxylic acids. Adipic acid, azelaic acid, sebacic acid, dodecanedioic acid (=decanedicarboxylic acid) and terephthalic and/or isophthalic acid may be mentioned as acids here.

Alkanediamines having 6 to 12, in particular 6 to 8, carbon atoms and m xylylenediamine, di (4-aminophenyl)methane, di-(4-aminocyclohexyl)methane, 2,2-di-(4-aminophenyl)propane or 2,2-di-(4-aminocyclohexyl)propane are particularly suitable as diamines.

Preferred polyamides are polyhexamethyleneadipamide (PA 66), polyhexamethylenesebacamide (PA 610), polyhexamethylenedecanedicarboxamide (PA 612), polycaprolactam (PA 6), copolyamides 6/66, in particular having a proportion of 5 to 95% by weight of caprolactam units, and polylaurolactam (PA 12) and PA 11, and moreover copolyamides based on caprolactam, terephthalic acid and hexamethylenediamine or based on terephthalic acid, adipic acid and hexamethylene diamine.

Polyamides which are obtainable, for example, by condensation of 1,4 diaminobutane with adipic acid at elevated temperature (PA 46) will also be mentioned. Preparation processes for polyamides of this structure are described, for example, in EP-A 0 038 094, EP-A0038582 and EP-A0039524.

Further examples are polyamides which are obtainable by copolymerization of two or more of the abovementioned monomers, or mixtures of a plurality of polyamides, any desired mixing ratio being possible.

The following non-definitive list contains the stated and further polyamides in the context of the invention (the monomers are stated in brackets): PA46 (tetramethylenediamine, adipic acid), PA66 (hexamethylenediamine, adipic acid), PA69 (hexamethylenediamine, azelaic acid), PA610 (hexamethylenediamine, sebacic acid), PA612 (hexamethylenediamine, decanedicarboxylic acid), PA613 (hexamethylenediamine, undecanedicarboxylic acid), PA614 (hexamethylenediamine, dodecanedicarboxylic acid), PA 1212 (1,12-dodecanediamine, decanedicarboxylic acid), PA1313 (1,13-diaminotridecane, undecanedicarboxylic acid), PA MXD6 (m-xylylenediamine, adipic acid), PA TMDT (trimethylhexamethylenediamine, terephthalic acid), PA 4 (pyrrolidone), PA 6 (ε-caprolactam), PA 7 (ethanolactam), PA 8 (capryllactam), PA 9 (9-aminopelargonic acid), PA 11 (11-aminoundecanoic acid), PA 12 (laurolactam). These polyamides and their preparation are known. The person skilled in the art can find details of their preparation in Ullmanns Encyklopädie der Technischen Chemie [Ullmann's Encyclopaedia of Industrial Chemistry], 4th Edition, Vol. 19, pages 39 54, Verlag Chemie, Weinheim 1980, and Ullmann's Encyclopaedia of Industrial Chemistry, Vol. A21, pages 179-206, VCH Verlag, Weinheim 1992, and Stoeckhert, Kunststofflexikon [Plastics Lexicon], 8th Edition, pages 425 428, Hanser Verlag, Munich 1992 (keyword “Polyamide [Polyamides]” et seq.).

Other suitable thermoplastic materials are vinylaromatic (co)polymers. The molecular weight of these polymers known per se and commercially available is in general in the range from 1500 to 2 000 000, preferably in the range from 70 000 to 1 000 000 g/mol.

Vinylaromatic (co)polymers of styrene, chlorostyrene, α-methylstyrene and p-methylstyrene may be mentioned here merely as being typical; comonomers such as (meth)acrylonitrile or (meth)acrylates may also be part of the composition in minor proportions (preferably not more than 30, in particular not more than 8, % by weight). Particularly preferred vinylaromatic (co)polymers are polystyrene, styrene-acrylonitrile copolymers (SAN) and impact-modified polystyrene (HIPS=high impact polystyrene). Of course, mixtures of these polymers may also be used. The preparation can be effected by the process described in EP-A-0 302 485. ASA, ABS and AES polymers (ASA=acrylonitrile-styrene-acrylate, ABS=acrylonitrile-butadiene-styrene, AES=acrylonitrile-EPDM rubber-styrene) are furthermore particularly preferred. These impact-resistant vinylaromatic polymers contain at least one elastomeric graft polymer and a thermoplastic polymer (matrix polymer). In general, a styrene/acrylonitrile polymer (SAN) is resorted to as matrix material. Graft polymers which contain a diene rubber based on dienes, for example butadiene or isoprene (ABS), an alkyl acrylate rubber based on alkyl esters of acrylic acid such as n butyl acrylate and 2-ethylhexyl acrylate, an EPDM rubber based on ethylene, propylene and a diene or mixtures of these rubbers or rubber monomers are preferably used.

The preparation of suitable ABS polymers is described in detail, for example, in DE-A 100 26 858 or in DE-A 197 28 629. For the preparation of ASA polymers it is possible to resort to, for example, EP-A 0 099 532. Information on the preparation of AES polymers is disclosed, for example, in U.S. Pat. No. 3,055,859 or in U.S. Pat. No. 4,224,419. Polyarylene ethers are preferably to be understood as meaning polyarylene ethers per se, polyarylene ether sulphides, polyarylene ether sulphones or polyarylene ether ketones. The arylene groups thereof may be identical or different and, independently of one another, denote an aromatic radical having 6 to 18 C atoms. Examples of suitable arylene radicals are phenylene, biphenylene, terphenylene, 1,5-naphthylene, 1,6-naphthylene, 1,5-anthrylene, 9,10-anthrylene or 2,6-anthrylene. Among these, 1,4-phenylene and 4,4′ biphenylene are preferred. These aromatic radicals are preferably not substituted. However, they may carry one or more substituents. Suitable polyphenylene ethers are commercially available under the name Noryl® (GE Plastics B. V., The Netherlands).

The polyarylene ethers are known per se or can be prepared by methods known per se.

Preferred process conditions for the synthesis of polyarylene ether sulphones or ketones are described, for example, in EP-A 0 113 112 and EP-A 0 135 130. Suitable polyphenylene ether sulphones are commercially available, for example, under the name Ultrason® E (BASF AG) and suitable polyphenylene ether ketones under the name VESTAKEEP® (Degussa GmbH).

Furthermore, polyurethanes, polyisocyanurates and polyureas are suitable materials for the production of shaped plastics articles. Flexible, semi-rigid or rigid, thermoplastic or crosslinked polyisocyanate polyadducts, for example polyurethanes, polyisocyanurates and/or polyureas, are generally known. Their preparation is widely described and is usually effected by reaction of isocyanates with compounds reactive towards isocyanates, under generally known conditions. The reaction is preferably carried out in the presence of catalysts and/or auxiliaries.

The aromatic, arylaliphatic, aliphatic and/or cycloaliphatic organic isocyanates known per se, preferably diisocyanates, are suitable as isocyanates.

For example, generally known compounds having a molecular weight of 60 to 10 000 g/mol and a functionality with respect to isocyanates of 1 to 8, preferably 2 to 6, can be used as compounds reactive towards isocyanates (in the case of thermoplastic polyurethanes, functionality about 2), for example polyols, such as polyether polyols, polyester polyols and polyether polyester polyols having a molecular weight of 500 to 10 000 g/mol and/or diols, triols and/or polyols having molecular weights of less than 500 g/mol.

Polylactides, i.e. polymers of lactic acid, are known per se and can be prepared by processes known per se.

In addition to polylactide, copolymers or block copolymers based on lactic acid and further monomers may also be used. In general, linear polylactides are used. However, it is also possible to use branched lactic acid polymers. For example, polyfunctional acids or alcohols may serve as branching agents.

For example, polymers of vinyl chloride may be mentioned as suitable halogen-containing polymers, in particular polyvinyl chloride (PVC), such as rigid PVC and flexible PVC, and copolymers of vinyl chloride, such as PVC-U moulding materials. Furthermore, fluorine-containing polymers are suitable, in particular polytetrafluoroethylene (PTFE), tetrafluoroethylene-perfluoropropylene copolymers (FEP), copolymers of tetrafluoroethylene with perfluoroalkyl vinyl ethers, ethylene-tetrafluoroethylene copolymers (ETFE), polyvinylidene fluoride (PVDF), polyvinyl fluoride (PVF), polychlorotrifluoroethylene (PCTFE) and ethylene-chlorotrifluoroethylene copolymers (ECTFE).

Polymers containing imido groups are in particular polyimides, polyetherimides and polyamidoimides.

Suitable cellulose esters are, for example, cellulose acetate, cellulose acetobutyrate and cellulose propionate.

In addition, silicone polymers are also suitable as thermoplastics. In particular, silicone rubbers are suitable. These are usually polyorganosiloxanes which have groups capable of crosslinking reactions. Such polymers are described, for example, in Römpp Chemie Lexikon [Römpp Chemistry Lexikon], CD-ROM version 1.0, Thieme Verlag Stuttgart 1995.

Finally, the class of compounds consisting of thermoplastic elastomers (TPE) may also be used. TPEs can be processed like thermoplastics but have elastomeric properties. TPE block copolymers, TPE graft copolymers and segmented TPE copolymers comprising two or more monomer building blocks are suitable. Particularly suitable TPEs are thermoplastic polyurethane elastomers (TPE-U or TPU), styrene oligoblock copolymers (TPE-S), such as SBS (styrene-butadiene-styrene block copolymer) and SEBS (styrene-ethylene-butylene-styrene block copolymer, obtainable by hydrogenation of SBS), thermoplastic polyolefin elastomers (TPE-O), thermoplastic polyester elastomers (TPE-E), thermoplastic polyamide elastomers (TPE-A) and in particular thermoplastic vulcanizates (TPE-V). The person skilled in the art can find details of TPE in G. Holden et al., Thermoplastic Elastomers, 2nd Edition, Hanser Verlag, Munich 1996. The shaped articles can moreover contain customary additives and processing auxiliaries.

Suitable additives and processing auxiliaries are, for example, lubricants or demoulding agents, rubbers, antioxidants, light stabilizers, antistatic agents, flame proofing agents or fibrous or pulverulent fillers or reinforcing materials and other additives or mixtures thereof.

Suitable lubricants and demoulding agents are, for example, stearic acid, stearyl alcohol, stearates or stearoamides, silicone oils, metal stearates, montan waxes and waxes based on polyethylene and polypropylene.

Suitable antioxidants (heat stabilizers) are, for example, sterically hindered phenols, hydroquinones, arylamines, phosphites, various substituted members of this group and mixtures thereof.

Suitable light stabilizers are, for example, various substituted resorcinols, salicylates, benzotriazoles, benzophenones and HALS (hindered amine light stabilizers).

Suitable antistatic agents, are, for example, amine derivatives such as N,N-bis(hydroxyalkyl)-alkylamines or -alkylenamines, polyethylene glycol esters or glyceryl mono- and distearates and mixtures thereof.

Suitable flame proofing agents are, for example, the halogen-containing compounds known to the person skilled in the art, alone or together with antimony trioxide, or phosphorus-containing compounds, magnesium hydroxide, red phosphorus and other customary compounds or mixtures thereof. These include, for example, the phosphorus compounds disclosed in DE-A 196 32 675 or those disclosed in Encyclopaedia of Chemical Technology, Editors R. Kirk and D. Othmer, Vol. 10, 3rd Edition, Wiley, New York, 1980, pages 340 to 420, such as phosphates, e.g. triaryl phosphates, such as tricresyl phosphate, phosphites, e.g. triaryl phosphites, or phosphonites. Bis(2,4-di-tert-butylphenyl)phenyl phosphonite, tris(2,4-di-tert-butylphenyl) phosphonite, tetrakis(2,4-di-tert-butyl-6-methylphenyl) 4,4′-biphenylylene diphosphonite, tetrakis(2,4-di-tert-butylphenyl) 4,4′-biphenylylene diphosphonite, tetrakis(2,4-dimethylphenyl) 1,4-phenylylene diphosphonite, tetrakis(2,4-di-tert-butylphenyl) 1,6-hexylylene diphosphonite and/or tetrakis(3,5-dimethyl-4-hydroxyphenyl) 4,4′-biphenylylene diphosphonite or tetrakis(3,5-di-tert-butyl-4-hydroxyphenyl) 4,4′-biphenylylene diphosphonite are as a rule used as phosphonites.

Inorganic flame proofing agents based on hydroxides or carbonates, in particular of magnesium, inorganic and organic boron compounds, such as boric acid, sodium borate, boron oxide, sodium tetraphenylborate and tribenzyl borate, nitrogen-containing flame proofing agents, such as iminophosphoranes, melamine cyanurate and ammonium polyphosphates and melamine phosphate, are furthermore suitable (also see Encyclopaedia of Chemical Technology, ibid.). Furthermore, mixtures with anti drip agents, such as Teflon or high molecular weight polystyrene, are also suitable as flame proofing agents.

Carbon fibers or glass fibers in the form of woven glass fabrics, glass mats or glass rovings, cut glass and glass beads, particularly preferably glass fibers, may be mentioned as examples of fibrous or pulverulent fillers and reinforcing materials. The glass fibers used may comprise E-, A- or C-glass and are preferably treated with a size, e.g. based on epoxy resin, silane, amino silane or polyurethane, and an adhesion promoter based on functionalized silanes. The incorporation of glass fibers can be effected both in the form of short glass fibers and in the form of rovings.

For example, amorphous silica, whiskers, alumina fibers, magnesium carbonate (chalk), powdered quartz, mica, bentonites, talc, feldspar or in particular calcium silicates, such as wollastonite and kaolin, are suitable as particulate fillers.

The fibers, pulverulent or particulate fillers and reinforcing materials are usually used in amounts of 1 to 60 and preferably 10 to 50% by weight, based on the shaped article.

On welding by means of electromagnetic radiation, the following embodiments of the invention are possible:
the shaped article or the film absorbs electromagnetic radiation in the wavelength range used without an additive being necessary, or
the absorption of the electromagnetic radiation is brought about by addition of an absorbing additive.

In both cases, one of the two parts is transparent to the electromagnetic radiation used while the other part absorbs the radiation. In every case, radiation is incident through the part transparent to the radiation.

The film used may be a one-layer film; in this case, it comprises material which undergoes strong adhesion to the material of the shaped article. If, owing to insufficient material compatibility, strong adhesion cannot be achieved with a one-layer film, a two-layer film can be used, one film layer being optimized for adhesion to the shaped article. If required by the application, the film may contain further layers over and above these. The production of such multilayer films, for example by co-extrusion, is part of the background art.

In general, the film is not more than 2000 μm, not more than 1600 μm, not more than 1200 μm, not more than 1000 μm, not more than 900 μm, not more than 800 μm, not more than 700 μm or not more than 600 μm thick, while the minimum thickness is 10 μm, 15 μm, 20 μm, 25 μm or 30 μm.

In a preferred embodiment, the film or its outward-directed layer comprises a moulding material based on a semicrystalline polyamide.

This semicrystalline polyamide is not subject to any limitation. Aliphatic homo- and copolymers, for example PA46, PA66, PA88, PA610, PA612, PA810, PA1010, PA1012, PA1212, PA6, PA7, PA8, PA9, PA10, PA 11 and PA 12, are primarily suitable here. (The characterization of the polyamides corresponds to an international standard, the first digit(s) specifying the number of carbon atoms of the starting diamine and the last digit(s) specifying the number of C atoms of the dicarboxylic acid. Only one number is mentioned, this means that an α,ω-aminocarboxylic acid or the lactam derived therefrom has been used as a starting material; besides, reference may be made to H. Domininghaus, Die Kunststoffe und ihre Eigenschaften [Plastics and their properties], pages 272 et seq., VDI-Verlag, 1976.)

If copolyamides are used, these may contain, for example, adipic acid, sebacic acid, subaric acid, isophthalic acid, terephthalic acid, naphthalene-2,6-dicarboxylic acid, etc. as a co-acid or bis(4-aminocyclohexyl)methane, bis(3-methyl-4-aminocyclohexyl)methane, trimethylhexamethylenediamine, hexamethylenediamine or the like as a co-diamine. Lactams, such as caprolactam or laurolactam, or aminocarboxylic acids, such as ω-aminoundecanoic acid, can likewise be incorporated as a co-component.

The preparation of these polyamides is known (for example D. B. Jacobs, J. Zimmermann, Polymerization Processes, pages 424-467, Interscience Publishers, New York, 1977; DE-B 21 52 194).

In addition, mixed aliphatic/aromatic polycondensates, as described, for example, in U.S. Pat. Nos. 4,163,101, 4,603,166, 4,831,108, 5,112,685, 5,436,294 and 5,447,980 and in EP-A-0 309 095, are also suitable. These are as a rule polycondensates, the monomers of which are selected from aromatic dicarboxylic acids, such as, for example, terephthalic acid and isophthalic acid, aliphatic dicarboxylic acids, such as, for example, adipic acid, aliphatic diamines, such as, for example, hexamethylenediamine, nonamethylenediamine, dodecamethylenediamine and 2-methyl-1,5-pentanediamine, and lactams or ω-aminocarboxylic acids, such as, for example, caprolactam, laurolactam and ω-aminoundecanoic acid. The content of aromatic monomer units in the polycondensate is as a rule at least 15%, at least 20%, at least 25%, at least 30%, at least 35%, at least 40%, at least 45% or about 50%, based on the sum of all monomer units. Such polycondensates are frequently referred to as “polyphthalamides” or “PPA”. Further suitable polyamides are poly(ether ester amides) or poly(ether amides); such products are described, for example, in DE-A 25 23 991, 27 12 987 and 30 06 961.

The semicrystalline polyamide has an enthalpy of fusion of at least 8 J/g, preferably of at least 10 J/g, particularly preferably of at least 12 J/g and especially preferably of at least 16 J/g, measured by the DSC method according to ISO 11357 with 2nd heating and integration of the melt peak.

The polyamide moulding material may contain either one of these polyamides or a plurality as a mixture. Furthermore, up to 40% by weight of other thermoplastics may be present, provided that these do not interfere with the bondability, in particular toughening rubbers, such as ethylene/propylene or ethylene/propylene/diene copolymers, polypentenylene, polyoctenylene, random or block copolymers of alkenylaromatic compounds with aliphatic olefins or dienes (EP-A-0 261 748) or core/shell rubbers having a tough and resilient core comprising (meth)acrylate, butadiene or styrene/butadiene rubber with glass transition temperatures T_{g}<−10° C., it being possible for the core to be crosslinked and for the shell to contain styrene and/or methyl methacrylate and/or further unsaturated monomers (DE-A 21 44 528, 37 28 685).

The auxiliaries and additives customary for polyamides, such as, for example, flame proofing agents, stabilizers, UV absorbers, plasticizers, processing auxiliaries, fillers, in particular for improving the electrical conductivity, nano fillers, pigments, dyes, nucleating agents or the like, may be added to the polyamide moulding material. The amount of said agents should be metered so that the desired properties are not seriously adversely affected. For most applications, it is desired that the polyamide moulding material be sufficiently transparent at the layer thickness used.

In a preferred embodiment, the monomer units of the polyamide which are derived from diamine, dicarboxylic acid or lactam (or aminocarboxylic acid) have on average at least 8 C atoms and particularly preferably at least 9 C atoms.

Polyamides particularly suitable in the context of the invention are:
the polyamide obtained from 1,12-dodecanedioic acid and 4,4′-diaminodicyclohexylmethane (PA PACM12), in particular starting from a 4,4′-diaminodicyclohexylmethane having a trans, trans-isomer proportion of 35 to 65%;
PA612, PA1010, PA1012, PA11, PA12, PA1212 and mixtures thereof;
copolyamides which are based on the following monomer combination:
a) 65 to 99 mol %, preferably 75 to 98 mol %, particularly preferably 80 to 97 mol % and especially preferably 85 to 96 mol % of a substantially equimolar mixture of an aliphatic straight-chain diamine and an aliphatic straight-chain dicarboxylic acid, the mixture being present, if desired, as a salt and moreover diamine and dicarboxylic acid being counted individually in each case in the calculation of the composition, with the limitation that the mixture of diamine and dicarboxylic acid contains on average 8 to 12 C atoms and preferably 9 to 11 C atoms per monomer;
b) 1 to 35 mol %, preferably 2 to 25 mol %, particularly preferably 3 to 20 mol % and especially preferably 4 to 15 mol % of a substantially equimolar mixture of a cycloaliphatic diamine and a dicarboxylic acid;
   copolyamides which are based on the following monomer combination:
a) 50-100 parts by weight, preferably 60-98 parts by weight, particularly preferably 70-95 parts by weight and especially preferably 75-90 parts by weight of polyamide which can be prepared from the following monomers:
   α) 70-100 mol %, preferably 75-99 mol %, particularly preferably 80-98 mol % and especially preferably 85-97 mol % of m- and/or p-xylylenediamine; and
   β) 0-30 mol %, preferably 1-25 mol %, particularly preferably 2-20 mol % and especially preferably 3-15 mol % of other diamines having 6 to 14 C atoms, the mol % data being based here on the sum of diamine, and
   γ) 70-100 mol %, preferably 75-99 mol %, particularly preferably 80-98 mol % and especially preferably 85-97 mol % of aliphatic dicarboxylic acids having 10 to 18 C atoms; and
   δ) 0-30 mol %, preferably 1-25 mol %, particularly preferably 2-20 mol % and especially preferably 3-15 mol % of other dicarboxylic acids having 6 to 9 C atoms;

the mol % data being based here on the sum of dicarboxylic acid;
b) 0-50 parts by weight, preferably 2-40 parts by weight, particularly preferably 5-30 parts by weight and especially preferably 10-25 parts by weight of another polyamide, preferably a polyamide having on average at least 8 C atoms in the monomer units, the parts by weight of a) and b) summing to 100.

In a further preferred embodiment, the film or its outward-directed layer comprises a moulding material based on a fluoropolymer, for example polyvinylidene difluoride (PVDF), ethylene/tetrafluoroethylene copolymers (ETFE) or terpolymers based on ethylene, tetrafluoroethylene and a termonomer which as a rule contains fluorine and is incorporated primarily for lowering the melting point. Such products are commercially available.

In further preferred embodiments, the film or its outward-directed layer comprises a moulding material based on a polyester or a polyolefin. Suitable polyesters are, for example, polyethylene terephthalate, polypropylene terephthalate, polybutylene terephthalate, polyethylene 2,6-naphthalate, polypropylene 2,6-naphthalate or polybutylene 2,6-naphthalate, whereas primarily polyethylene (in particular HDPE, LDPE and LLDPE) and polypropylene (isotactic or syndiotactic, homopolymer as well as copolymers with ethene and/or 1-butene, random copolymers being preferred here) are suitable as the polyolefin.

In the case of an inward-directed film layer which acts as an adhesion promoter, moulding materials are chosen which are known to be suitable for the chosen material combination. Frequently used adhesion promoters are, for example, polyolefins which are modified with unsaturated carboxylic acids or unsaturated acid anhydrides. A number of such products are commercially available under the trade names ADMER® and BYNEL®.

Other known adhesion promoters contain the polymers of the shaped article and of the outward-directed film layer and, if desired, a compatibilizer.

Additives which absorb electromagnetic radiation form part of the background art. The absorbing additive may be, for example, carbon black. Further suitable absorbing additives are bone charcoal, graphite, other carbon particles, copper hydroxide phosphate (KHP), dyes, pigments or metal powder. Interference pigments, as described, for example, in EP-A-0 797 511, are also suitable; corresponding products are sold under the trade name Iriodin®. The additives described in WO 00/20157 and WO 02/38677 (e.g. ClearWeld®) or the additives of the product series Lumogen® IR (BASF AG) are also suitable.

In addition, the following are also suitable: mica or mica pigments, titanium dioxide, kaolin, antimony(III) oxide, metal pigments, pigments based on bismuth oxychloride (e.g. Biflair series from Merck, high-lustre pigment), indium tin oxide (Nano ITO powder, from Nanogate Technologies GmbH or AdNano™ ITO from Degussa), AdNano™ zinc oxide (Degussa), lanthanum hexaboride, antimony tin oxide and commercially available flame proofing agents which comprise melamine cyanurate or phosphorus, preferably phosphates, phosphites, phosphonites or elemental (red) phosphorus.

If it is intended to avoid adversely affecting the natural colour, the absorber preferably comprises interference pigments, particularly preferably from the Iriodin LS series from Merck, or ClearWeld®.

The carbon black can be prepared by the furnace black process, the gas black process or the flame black process, preferably by the furnace black process. The primary particle size is from 10 to 100 nm, preferably from 20 to 60 nm, and the particle distribution can be narrow or broad. The BET surface area according to DIN 53601 is from 10 to 600 m²/g, preferably from 70 to 400 m²/g. The carbon black particles can be oxidatively aftertreated for establishing surface functionalities. They can be rendered hydrophobic (for example Printex 55 or flame black 101 from Degussa) or hydrophilic (for example Farbruss FW20 or Printex 150 T from Degussa). They may be highly structured or have little structure; a degree of aggregation of the primary particles is described thereby. By using special conductive carbon blacks, electroconductivity of the components produced from the powder according to the invention can be adjusted. By using beaded carbon blacks, better dispersibility can be utilized both in the wet and in the dry mixing processes. The use of carbon black dispersions may also be advantageous.

Bone charcoal is a mineral black pigment which contains elemental carbon. It comprises 70 to 90% of calcium phosphate and 30 to 10% of carbon. The density is typically from 2.3 to 2.8 g/ml.

The absorber may also contain a mixture of organic and/or inorganic pigments, flame proofing agents or other colorants, which each by themselves do not absorb or absorb poorly at the wavelengths from 100 to 3000 nm, but in combination absorb the introduced electromagnetic energy sufficiently well for use in the method according to the invention.

The concentration of the absorbing additive in the moulding material is usually 0.05 to 20% by weight, preferably 0.1 to 5% by weight and particularly preferably 0.2 to 1.5% by weight.

The welding is carried out according to the background art, advisedly under contact pressure.

The electromagnetic radiation is not limited with regard to the frequency range. It may be, for example, microwave radiation, IR radiation or preferably laser radiation.

The laser radiation used in the method according to the invention generally has a wavelength in the range from 150 to 11 000, preferably in the range from 700 to 2000 and particularly preferably in the range from 800 to 1100 nm.

In principle, all customary lasers are suitable, for example gas lasers and solid-state lasers. Examples of gas lasers are (the typical wavelength of the emitted radiation is stated in brackets): CO₂ lasers (10 600 nm), argon gas lasers (488 nm and 514.5 nm), helium-neon gas lasers (543 nm, 632.8 nm, 1150 nm), krypton gas lasers (330 to 360 nm, 420 to 800 nm), hydrogen gas lasers (2600 to 3000 nm), nitrogen gas lasers (337 nm); examples of solid-state lasers are (the typical wavelength of the emitted radiation is in brackets): Nd:YAG lasers (Nd³⁺:Y₃Al₅O₁₂) (1064 nm), high-performance diode lasers (800 to 1000 nm), ruby lasers (694 nm), F₂ excimer lasers (157 nm), ArF excimer lasers (193 nm), KrCl excimer lasers (222 nm), KrF excimer lasers (248 nm), XeCl excimer lasers (308 nm), XeF excimer lasers (351 nm) and frequency-multiplied Nd:YAG lasers having wavelengths of 532 nm (frequency-doubled), 355 nm (frequency-tripled) or 266 nm (frequency-quadrupled).

The lasers used are usually operated at powers of 1 to 200, preferably 5 to 100 and in particular 10 to 50 watt.

The energy densities of the lasers used are stated in the literature as so-called “energies per unit length” and, in the present invention, are generally in the range from 0.1 to 50 J/mm. The actual energy density is defined as power introduced/weld area produced. This value is equivalent to the ratio of energy per unit length to width of the weld seam produced. The actual energy densities of the lasers used are usually 0.01 to 25 J/mm². The energy density to be chosen depends not only on the reflection properties of the transparent body but also, inter alia, on whether the shaped plastics articles to be joined contain fillers or reinforcing materials or other strongly laser-absorbing or laser-scattering substances. For polymers which have a low reflection and contain no fillers or reinforcing materials, the energy densities are usually 1 to 20, in particular 3 to 10, J/mm. For polymers which contain fillers or reinforcing materials, they are usually 3 to 50, in particular 5 to 20, J/mm.

Corresponding lasers which can be used in the process according to the invention are commercially available.

Particularly preferred lasers emit in the short-wave infrared range. Such particularly preferred lasers are solid-state lasers, in particular the Nd:YAG lasers (1064 nm) and high-performance diode lasers (800 to 1000 nm).

If the shaped article absorbs the electromagnetic radiation used, the radiation is incident through the film. In this case, the film is sufficiently transparent to the radiation.

However, it is also possible to use a shaped article transparent to the radiation and an absorbing one-layer film; in this case, the radiation is incident through the shaped article.

In a further embodiment, a multi-layer film whose inward-directed layer (i.e. towards the shaped article) is absorbing is used. In this case, the radiation can be incident through the film. If the shaped article is sufficiently transparent, however, the radiation can also be incident through the shaped article.

In the case of a transparent film or outer layer, it is advantageous if the film or outer layer does not also melt. As a result, the contact pressure does not produce any marks on the surface. It is thus advantageous to tailor the melting and softening ranges of the outer layer or film (in the case of a one-layer embodiment), possible adhesion promoter layer and the shaped article to one another. Preferably, the melting or softening range of the adhesion promoter is lower than that of the outer layer. In the case of a one-layer film, it is preferable if the melting or softening range of the material of the shaped article is lower.

The film (in the case of a one-layer embodiment) or the outer layer (i.e. the outward-directed layer of a multilayer film) can meet a very wide range of requirements. It may have a protective function with good scratch resistance, UV stability, heat stability or resistance to chemicals or, if it is sufficiently transparent, may be imprinted on the back, as a result of which the imprint cannot be removed or scratched off. For example, by means of the process according to the invention, polyolefin surfaces, e.g. bottles, can be provided with films, e.g. in the form of labels, without pretreatment. The application of emblems or of protective films is just as possible as the surface decoration or the inscription or marking of safety-relevant components or the application of proof of origin or warranty or safety information. Even relatively small quantities can be easily and reliably produced with the aid of this technique.

On welding, the film can be pressed on by means of a sphere or a roller. The beam can be guided through a sufficiently transparent pressure roller. Alternatively, the beam can also be introduced briefly behind or between two rollers. The film can also be sucked against the shaped article by means of a vacuum or joined by means of a combination of pressure roller and vacuum.

In a particularly suitable embodiment, the laser beam is focused via a rotatable spherical glass lens which simultaneously serves as a mechanical pressure tool. With this variant of the method, complex components having a three-dimensional joint seam can also be welded. An air-supported, rotatable spherical glass lens introduces the contact pressure at the joint area. The contact pressure point is constantly present on the axis of the optical system so that the laser radiation is incident only where the contact pressure is present. This guarantees a high weld quality even in the case of complex three-dimensional geometries.

German patent application 10 2007 038578.3 filed Aug. 16, 2007, is incorporated herein by reference.

Numerous modifications and variations on the present invention are possible in light of the above teachings. It is therefore to be understood that within the scope of the appended claims, the invention may be practiced otherwise than as specifically described herein.

1. A method for the production of a surface-decorated shaped article, comprising:
a) providing a shaped article; and
b) welding at least a portion of the surface of the shaped article to a decorating film with incidence of electromagnetic radiation.

2. The method according to claim 1, wherein the shaped article is produced by a mouldless method operating layer by layer.

3. The method according to claim 1, wherein the shaped article comprises 1 to 60% by weight of a filler, a reinforcing material or mixtures thereof.

4. The method according to claim 1, wherein the film is a one-layer or multilayer film.

5. The method according to claim 1, wherein the film or the outward-directed layer of the film comprises a moulding material based on semicrystalline polyamide, fluoropolymer, polyester or polyolefin.

6. The method according to claim 1, wherein the electromagnetic radiation is laser radiation.

7. The method according to claim 1, wherein said shaped article comprises a thermoplastic polymer.

8. The method according to claim 1, wherein the shaped article or the film absorbs electromagnetic radiation in the wavelength range used without use of an additive.

9. The method according to claim 1, wherein the shaped article or the film absorbs electromagnetic radiation in the wavelength range used with use of an absorbing additive.

10. The method according to claim 8, wherein one of (i) the shaped article or (ii) the film is transparent to the electromagnetic radiation used while the other part absorbs the radiation.

11. The method according to claim 9, wherein one of (i) the shaped article or (ii) the film is transparent to the electromagnetic radiation used while the other part absorbs the radiation.

12. The method according to claim 10, wherein the radiation is incident through the part transparent to the radiation.

13. The method according to claim 11, wherein the radiation is incident through the part transparent to the radiation.

14. The method according to claim 1, wherein the film has a thickness of from 10 to 2000 μm.

15. The method according to claim 1, wherein the electromagnetic radiation is microwave radiation, IR radiation or laser radiation.

16. The method according to claim 1, wherein the electromagnetic radiation is laser radiation having a wavelength in the range from 150 to 11 000 nm.

17. The method according to claim 1, wherein the shaped article is transparent to the radiation and the decorating film is an absorbing one-layer film;
wherein the radiation is incident through the shaped article.

18. The method according to claim 1, wherein a multi-layer film whose inward-directed layer, directed towards the shaped article, is absorbing said electromagnetic radiation; and
wherein the radiation is incident through the film. If the shaped article is sufficiently transparent, however, the radiation can also be incident through the shaped article.

19. The method according to claim 1, wherein the film is pressed on during welding by using a sphere or a roller.

20. The method according to claim 6, wherein a laser beam is focused via a rotatable spherical glass lens which simultaneously serves as a mechanical pressure tool.
